(19) United States
(12) Patent Application Publication
(10) Pub. No.: US 2004/0161233 A1
(43) Pub. Date: Aug. 19, 2004

(54) Method and apparatus for in-channel OSNR estimation

(75) Inventors: Zeev Zalevsky, Rosh-Haayin (IL); Vardit Eckhouse, Tel-Aviv (IL)

Correspondence Address: William H. Dippert, Esq., c/o Reed Smith LLP, 29th Floor, 599 Lexington Avenue, New York, NY, 10022-7650, US

(73) Assignee: Civcom Devices & Systems Ltd., Petach-Tikva (IL)

(21) Appl. No.: 10/695,519

(22) Filed: Oct. 28, 2003

(30) Foreign Application Priority Data
Oct. 28, 2002 (IL) 152519

(51) Int. Cl. H04B 10/08

(52) U.S. Cl. 398/26

(57) ABSTRACT

A method of in-channel estimation of the OSNR of an optical signal comprising a series of transmitted data units, each data unit having one of a discrete set of different amplitudes, the method comprising:

a) selecting a portion of the signal;

b) measuring, at least once, at least an indication of the selected portion of the signal;

c) repeating selecting a portion of the signal, and measuring; and

d) estimating the OSNR from the results of at least one of the measurements;

wherein consecutive measurements begin at times which differ by more than a shortest interval from one data unit to the next data unit.

### RELATED APPLICATION

This application is related to and claims priority from application number 152519, filed in Israel on 28 Oct. 2002, the disclosure of which is incorporated herein by reference.

### FIELD OF THE INVENTION

The field of the invention is optical communication and computation, especially with digital optical signals. It is also applicable to other types of digital signals, for example using microwaves.

### BACKGROUND OF THE INVENTION

Optical networks are used for communication and for all-optical computation, providing potentially much wider bandwidth than electronic networks. It is often important to know the Optical Signal to Noise Ratio (OSNR) in an optical network, in order to isolate faults in the network. OSNR can also be used to estimate the value of Amplifier Spontaneous Emission (ASE) noise and can be used for estimating the Bit Error rate (BER) or the Q factor of the incoming signal stream. Since the signal is much stronger than the noise, the computation of this ratio is commonly performed by measuring the noise in between adjacent WDM (Wavelength Domain Multiplexing) channels. However, different WDM channels may have different levels of noise and signal, and in many cases, signals pass through filters that filter out the wavelengths (including the noise) between channels. Thus, in order to evaluate the true Optical Signal to Noise Ratio (OSNR) one needs to estimate the OSNR within the channel.

One way to succeed in this task is to develop a technique in which the signal is depressed much more strongly than the noise. A direct approach in the case of a digital signal consisting of a stream of bits, 1's and 0's, would be to measure the signal within intervals of one bit, determine if each bit is a 1 or a 0, and look at the spread in amplitude of all the 1's, and the spread in amplitude of all the 0's, to find the noise. However, in the case of the highest bandwidth optical signals, currently 10 GHz or more, this would require using very expensive electronics, with much higher bandwidth than 10 GHz, to make the measurements.

Several techniques are known for suppressing the signal relative to the noise which use lower bandwidth, less expensive electronics. The most common technique is polarization nulling, described by D. K. Jung, C. H. Kim, and Y. C. Chung, “OSNR monitoring technique using polarization-nulling method,” Optical Fiber Conf. '2000 Tech. Dig, Baltimore, Md., March 2000, paper WK4-2, and by J. H. Lee and Y. C. Chung, “An improved OSNR monitoring technique based on polarization-nulling method,” Optical Fiber Conf. '2001 Tech. Dig, Anaheim, Cailf., March 2001, paper TuP6. In polarization nulling, use is made of the fact that the polarization of the signal varies slowly while the noise is non-polarized. A polarization controller changes the polarization state of the incoming signal such that when it is passed through a polarized beam splitter one output is the noise and the other output is the noise and the signal. However, this technique may fail in the presence of Polarization Mode Dispersion (PMD), since then the signal itself is not perfectly polarized. Another approach, the orthogonal delayed-homodyne method, is described by C. J. Youn, K. J. Park, J. H. Lee and Y. C. Chung, “OSNR monitoring technique based on orthogonal delayed-homodyne method,” Optical Fiber Conf. '2002 Tech. Dig, Anaheim, Cailf., March 2002. This method may work even with relatively high values of PMD. However, it requires expensive equipment for high rate spectral analysis, and it obtains spectral nulling of the signal in a very localized region that contains only a small amount of energy.

### SUMMARY OF THE INVENTION

An aspect of an embodiment of the invention concerns using low bandwidth electronics to estimate the OSNR of a high bandwidth optical signal. The measurement is accomplished by first transforming the signal in such a way that low bandwidth data can be used to infer the OSNR of the original high bandwidth signal. The transformation, for example, encodes a sequence of a few high bandwidth bits as an amplitude and a phase of a single low bandwidth piece of information. The noise level of the original high bandwidth signal is inferred from the measured noise in the signal and phase of the transformed signal.

Before the original signal is transformed, it is temporally gated to admit sequences of only a few bits at a time, for example 6 bits at a time. In order not to interrupt the signal, this gating is only done to a portion of the signal, which is drawn off to measure the OSNR.

The transformation, and the timing of the gating, are optionally chosen so that the transformed signal at a given time depends almost entirely on the bits in one gated sequence, and hardly at all on the previous or following gated bit sequences. The transformation and gating are optionally chosen so that the amplitude and phase of the transformed signal differ substantially for different sequences of bits. With a transformation and gating chosen to satisfy these conditions, the amplitude and phase of the transformed signal typically have a finite number of discrete pairs of values, in the absence of noise. For example, if each gated sequence has 6 bits, then the amplitude and phase of the transformed signal can have 64 different pairs of values, one for each possible sequence of 6 binary digits. The noise in the amplitude and phase is found, for example, by taking the difference between the measured amplitude and phase of the transformed signal, and the closest one of the 64 pairs of discrete amplitude and phase values, for each gated sequence of bits.

The method is not limited to optical signals, but is applicable to microwaves or other types of signals, using suitable hardware for transmitting, gating, transforming, and detecting the signals. The use of “optical” herein is not meant to exclude embodiments of the invention using other types of signals.

The method may be used to measure noise or signal distortions due to a variety of causes, including amplifier spontaneous emission, amplitude fluctuations, and chromatic dispersion, and may be used to estimate the bit error rate caused by the noise or distortions.

There is thus provided in accordance with an exemplary embodiment of the invention, a method of in-channel estimation of the OSNR of an optical signal comprising a series of transmitted data units, each data unit having one of a discrete set of different amplitudes, the method comprising:

a) selecting a portion of the signal;

b) measuring, at least once, at least an indication of the selected portion of the

c) repeating selecting a portion of the signal, and measuring; and

d) estimating the OSNR from the results of at least one of the measurements; wherein consecutive measurements begin at times which differ by more than a shortest interval from one data unit to the next data unit. Optionally, the method includes transforming the selected portion of the signal before measuring, wherein the indication of the selected portion of the signal comprises the transformed signal. Optionally, selecting a portion of the signal comprises temporally gating the signal to admit a sequence of N data units, where N is an integer, and repeating selecting a portion of the signal comprises repeating the temporal gating with the same or a different integer N.

In an exemplary embodiment of the invention, the data units are transmitted at substantially same time intervals.

In an exemplary embodiment of the invention, estimating the OSNR comprises determining a difference between the result of each of the at least one measurements, and an expected noiseless result of said measurement. Optionally, the method includes calculating the expected noiseless result for each of the at least one measurements.

In an exemplary embodiment of the invention, repeating the temporal gating comprises using a same N for each of a plurality of the repetitions. Optionally, said N is greater than 7. Alternatively, N is 7. Alternatively, N is 6. Alternatively, N is 5. Alternatively, N is 4. Alternatively, N is 2 or 3.

In an exemplary embodiment of the invention, the discrete set comprises only two different amplitudes.

In an exemplary embodiment of the invention, one of the amplitudes in the discrete set is zero.

In an exemplary embodiment of the invention, for at least one repetition, gating the signal comprises blocking N/2 or fewer data units after admitting the sequence of N data units.

In an exemplary embodiment of the invention, for at least one repetition, gating the signal comprises blocking between N/2 and N data units after admitting the sequence of N data units.

In an exemplary embodiment of the invention, for at least one repetition, gating the signal comprises blocking between N and 2N data units after admitting the sequence of N data units.

In an exemplary embodiment of the invention, for at least one repetition, gating the signal comprises blocking more than 2N data units after admitting the sequence of N data units.

In an exemplary embodiment of the invention, the transformation is linear. Alternatively, the transformation is nonlinear.

In an exemplary embodiment of the invention, the transformation comprises a frequency filter.

In an exemplary embodiment of the invention, the frequency filter comprises a low-pass filter. Optionally, the filter is symmetric around the carrier frequency of the optical signal. Optionally, the filter has at least one local maximum located on each side of the carrier frequency. Alternatively, the filter comprises a Kaiser window.

In an exemplary embodiment of the invention, repeating the temporal gating comprises using a same value of N for each repetition, and a bandwidth of the filter, defined as full width at half maximum, is less than the average data unit transmission rate divided by N, but greater than or equal to 70% of the average data unit transmission rate divided by N.

In an exemplary embodiment of the invention, repeating the temporal gating comprises using a same value of N for each repetition, and a bandwidth of the filter, defined as full width at half maximum, is less than 70% of the average data unit transmission rate divided by N, but greater than or equal to 50% of the average data unit transmission rate divided by N.

In an exemplary embodiment of the invention, repeating the temporal gating comprises using a same value of N for each repetition, and a bandwidth of the filter, defined as full width at half maximum, is less than 50% of the average data unit transmission rate divided by N, but greater than or equal to 30% of the average data unit transmission rate divided by N.

In an exemplary embodiment of the invention, repeating the temporal gating comprises using a same value of N for each repetition, and a bandwidth of the filter, defined as full width at half maximum, is less than 30% of the average data unit transmission rate divided by N.

In an exemplary embodiment of the invention, measuring comprises measuring with only one detector.

In an exemplary embodiment of the invention, the consecutive measurements begin at times which differ by at least two times the shortest interval. Optionally, the consecutive measurements begin at times which differ by at least five times the shortest interval.

In an exemplary embodiment of the invention, the consecutive measurements begin at times which differ by at least N/2 times the shortest interval, for the smallest N. Optionally, the consecutive measurements begin at times which differ by at least N times the shortest interval, for the smallest N.

In an exemplary embodiment of the invention, the consecutive measurements begin at times which differ by at most 10 times the shortest interval.

In an exemplary embodiment of the invention, calculating an expected noiseless result for each measurement comprises:

a) calculating a set of expected results, one for each member of a set of possible sequences of data units, each data unit having one of the discrete set of amplitudes; and

b) determining which result from the set of expected results is closest to the actual result of said measurement. Optionally, repeating gating the signal comprises using a same value of N for each repetition, and the set of possible sequences of data units comprises all of the possible sequences of N data units, each data unit having one of the discrete set of amplitudes.

In an exemplary embodiment of the invention, measuring at least once comprises making a first measurement and a second measurement for each of a plurality of the sequences. Optionally, estimating the OSNR comprises:

a) grouping the plurality of the sequences into clusters, according to a distribution of the results of the first and second measurements for each sequence in the plurality;

b) calculating a spread of the sequences in each cluster; and

c) using the spread of the sequences in at least one cluster to estimate the OSNR. Optionally, the method includes storing the measurement results for each sequence in the plurality before grouping the plurality of sequences into clusters, and grouping comprises using the stored results. Optionally, grouping the sequences comprises using an algorithm which assigns a sequence to clusters based on the measurement results of said sequence and on a distribution of measurement results of previously assigned sequences, and not on the measurement results of other sequences.

In an exemplary embodiment of the invention, calculating a spread comprises:

a) calculating a variance of at least one function of first measurement results and second measurement results in said cluster; and

b) setting the spread equal to a function of the at least one variances.

In an exemplary embodiment of the invention, the method includes:

a) analytically calculating the spread in the at least one cluster that would be obtained with a known value of OSNR;

b) calibrating the relationship between the spread in the at least one cluster and the OSNR, using the calculated spread.

In an exemplary embodiment of the invention, the method includes:

a) experimentally measuring the spread in the at least one cluster that is obtained with a known value of OSNR;

b) calibrating the relationship between the spread in the at least one cluster and the OSNR, using the experimentally measured spread.

In an exemplary embodiment of the invention, the plurality of the sequences comprises a sufficiently large number of the sequences so that at least one of the clusters has at least two sequences.

In an exemplary embodiment of the invention, for each sequence in the plurality, the first measurement is made starting at a same first time after the beginning of the transmission of the first data unit in said sequence, and the second measurement is made starting at a same second time after said beginning.

In an exemplary embodiment of the invention, for each sequence in the plurality, the first measurement is a measurement of amplitude and the second measurement is a measurement in phase.

In an exemplary embodiment of the invention, for each sequence in the plurality, the first and second measurements are measurements of amplitude.

In an exemplary embodiment of the invention, for each sequence in the plurality, the first and second measurements are measurements of phase.

In an exemplary embodiment of the invention, estimating the OSNR comprises calculating an average value of the differences determined for a plurality of the at least one measurements. Optionally, the average value is the root mean square of the differences.

In an exemplary embodiment of the invention, the method includes calibrating the relation between the average value and the OSNR by analytically modeling the average value that would be obtained with a known OSNR.

In an exemplary embodiment of the invention, the method includes calibrating the relation between the average value and the OSNR by experimentally finding the average value using a known OSNR.

There is also provided in accordance with an exemplary embodiment of the invention, apparatus adapted for in-channel estimation of the OSNR of a digital signal comprising a series of data units transmitted at a data rate less than or equal to a maximum data rate, each data unit having one of a discrete set of different amplitudes, the apparatus comprising:

a) a gate which gates the digital signal, selectively blocking data units transmitted at some times while allowing data units transmitted at other times to pass through;

b) a filter which filters the gated signal, substantially reducing frequency components at frequencies comparable to the maximum data rate;

c) a detector which makes measurements of the filtered signal; and

d) a data analyzer which is operative to estimate the OSNR using results of the measurements. Optionally, the apparatus includes a controller which controls the detector to make measurements during specified intervals of time related to the timing of the gate.

In an exemplary embodiment of the invention, the gate is capable of going from a closed state where the data units are substantially blocked, to an almost fully open state where the fraction of admitted signal power is close to its maximum value, in a response time that is less than the time needed to transmit five data units at the maximum data rate. Optionally, the response time is less than the time needed to transmit one data unit at the maximum data rate. Optionally, the response time is less than one fifth of the time needed to transmit one data unit at the maximum data rate.

In an exemplary embodiment of the invention, the detector is substantially less sensitive at the maximum data rate than it is at substantially lower frequencies.

In an exemplary embodiment of the invention, the detector has a measurement repetition time that is longer than the time needed to transmit one data unit at the maximum data rate. Optionally, the measurement repetition time is longer than the time needed to transmit two data units at the maximum data rate. Optionally, the measurement repetition time is longer than the time needed to transmit five data units at the maximum data rate.

In an exemplary embodiment of the invention, the apparatus is portable, and is adapted to be serve as a OSNR analyzer for a plurality of different optical networks.

There is also provided in accordance with an exemplary embodiment of the invention, an optical network comprising:

a) an optical path carrying an optical signal comprising a series of transmitted data units, each data unit having one of a discrete set of different amplitudes;

b) an apparatus for the in-channel estimation of the OSNR, as described herein; and

c) a beam divider for diverting a portion of the power of the optical signal from the optical path to the apparatus. Optionally, the beam divider is a partially reflecting substantially flat surface oriented at an oblique angle to the optical path.

### BRIEF DESCRIPTION OF THE DRAWINGS

Exemplary embodiments of the invention are described in the following sections with reference to the drawings. The drawings are generally not to scale and the same or similar reference numbers are used for the same or related features on is different drawings.

FIG. 1 is a schematic drawing showing an apparatus for in-channel estimation of OSNR, according to an exemplary embodiment of the invention;

FIG. 2 is a plot showing the calculated values of intensity of a gated, frequency-filtered signal at two different times, in the absence of noise, for a particular frequency filter, for each of the 64 different possible sequences of 6 binary bits, according to the embodiment shown in FIG. 1;

FIG. 3 is a plot of minimum distance between any two of the points shown in a plot like that of FIG. 2, as a function of bandwidth of the frequency filter, according to the embodiment shown in FIG. 1; and

FIG. 4A shows a simulated plot of a distribution of the points plotted in FIG. 2, in the presence of added white noise, according to the embodiment shown in FIG. 1; and

FIG. 4B shows a simulated plot similar to that of FIG. 4A, but with amplitude noise instead of added white noise, according to the embodiment shown in FIG. 1.

### DETAILED DESCRIPTION OF EXEMPLARY EMBODIMENTS

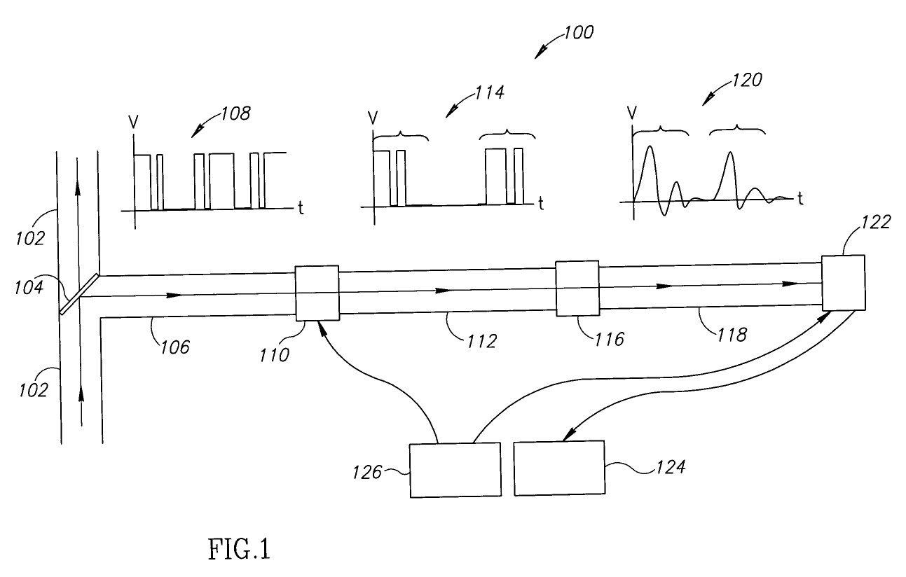

FIG. 1 schematically shows an apparatus 100 for in-channel estimation of OSNR. The method used optionally does not depend on polarization measurements, in some embodiments, in contrast to polarization nulling and related techniques.

The apparatus receives a wide bandwidth digital optical signal traveling through an optical fiber 102, and optionally diverts part of the signal power (using a half-silvered mirror 104, for example) as a signal 108 in an optical fiber 106. The diverted signal is temporally gated at a gate 110, producing a gated signal 114 in an optical fiber 112. The gated signal (for example, sequences of six bits at a time, separated by somewhat longer periods when the signal is blocked) is then transformed by a filter 116 (for example, a low pass filter), producing a transformed signal 120 in an optical fiber 118. The amplitude and phase of the transformed signal are then measured at a detector 122, which optionally is a relative inexpensive detector with relatively slow electronics, substantially lower in bandwidth than the original signal in optical fiber 102. Optionally, a controller 126 controls both gate 110 and detector 122, and coordinates the time at which detector 122 measures the amplitude and phase, relative to the timing of gate 110. The results of these measurements are analyzed by a digital signal processor 124, to obtain an estimate of the OSNR of the original signal in fiber 102.

Alternatively, instead of a separate filter 116, the filter is part of detector 122. Optionally, instead of a filter that operates on the optical signal, there is a filter located between the detector and an electronic interface which produces a processed electrical output signal from the detector, and the filter operates on an electrical signal, for example a raw electrical output signal of the detector. In this case, the detector itself preferably has a high bandwidth, and the controller controls the timing of the processed output signal, instead of or in addition to controlling the timing of the raw output.

Alternatively, instead of or in addition to using half-silvered mirror 104, any other method known in the art is used to draw off part of the optical signal power into fiber 106. For example, fiber 106 is not in direct contact with fiber 102, but is close enough to fiber 102 that it picks up an evanescent wave outside fiber 102. Alternatively, instead of drawing off part of the optical signal power from fiber 102, the estimate of OSNR is made directly in fiber 102, using the full signal. However, drawing off part of the signal in order to make the estimate has the advantage that the signal in fiber 102 is not blocked. If the OSNR estimate were made directly in fiber 102, with a gate, a filter, and a detector in series in fiber 102, then part of the signal would be lost when gate 110 blocks the signal. Alternatively, the original signal is divided into two or more parallel optical fibers, each with its own gate, filter, and detector, and the OSNR estimate is made using all of them, but in each of the parallel optical fibers the gate blocks the signal at different times, so none of the signal is lost. The signal may then be reconstructed using the gated, filtered signals in all the parallel paths. This alternative has the advantage that the fall signal power is used to estimate OSNR, but has the potential disadvantage that the system is much more complicated.

In fiber 106, as in fiber 102, signal 108 comprises a series of data units, each data unit being, for example, a binary bit, either 0 or 1. An example of such a signal is shown in FIG. 1 in a plot of signal 108, which shows signal intensity vs. time. Alternatively, the data units of different values differ in phase instead of or in addition to differing in intensity. Alternatively, whether the data units differ in amplitude or phase or both, each data unit has one of more than two discrete values. For example, each data unit is optionally a ternary digit, with any of three discrete values, or an octal digit, with any of 8 discrete values. It will be clear to one skilled in the art how to generalize the method to a digital signal whose data units each have one of any number of discrete values, or whose data units differ in phase rather than or in addition to differing in amplitude. In the rest of this description, the term “bit” will sometimes be used interchangeably with “data unit,” but it should be understood that the data units optionally have more than two possible values and each carry more than one bit of information. Similarly, it should be understood that when data units are described as having different amplitudes, they alternatively have different phases, or different phases and different amplitudes.

Optical Gate

The optical signal in fiber 106 optionally passes through gate 110, which admits a sequence of a certain number of data units (i.e. bits, in the case of a binary signal) to fiber 112, then blocks the signal for a certain number of data units (not necessarily the same as the number of data units admitted), and then repeats the process. Gating the signal has the potential advantage that each sequence of admitted data units is separated in time from the preceding and following sequences of data units, and the different sequences do not interfere with each other significantly. A plot of signal 114 shows an example of the signal in fiber 112, after it has been gated, with repeated sequences of six data units, and intervals of ten data units in between the admitted sequences, where the signal is blocked by gate 110.

The number of data units in each sequence need not be the same, but if sequences with different numbers of data units are used, then they may all be considered to have the length of the longest sequence, and the shorter sequences may be considered to be padded with data bits of zero amplitude. The number of data units between sequences, when the signal is blocked, need not be the same for all sequences.

Typically, each data unit will last for the same time interval, but this need not be the case. In particular, if corresponding data units in different admitted sequences each last for a same time interval, or if all data units last for time intervals that are small integer multiples of a same shorter time interval, then the method described here may work reasonably well. In the latter case, all data units may be considered to last for the shorter time interval, and data units of longer time intervals may each be considered repetitions of data units of the shorter time interval.

Optionally, optical gate 110 goes between a closed state where the signal is blocked, and an open state where the signal is fully admitted, in a time short compared to an interval of one data unit, for example one-tenth of a date unit, or even less, including any ringing or other transient responses of the gate, and optionally the gate is synchronized with the signal, so that the gate always opens and closes near the beginning of a data unit. This is the case, for example, in FIG. 1, where, for each data unit, signal 114 is either at full amplitude, or completely blocked. Alternatively, optical gate 110 opens and closes gradually, over a time comparable to the interval of one data unit, or even several data units, and/or the opening and closing of optical gate 110 is not very well synchronized, or not synchronized at all, with the signal. Even in these cases, the apparatus may still work well in some embodiments of the invention.

For example, if the gate is well synchronized with the signal, and the following conditions are satisfied, then the apparatus may work almost as if the gate opened and closed instantaneously: 1) The optical gate opens and closes with a consistent time profile. 2) The optical gate does not open or close so gradually that the first data unit or the last unit in each sequence is so reduced in amplitude that it is comparable to the noise level when the gate is fully open. 3) The gate closes sufficiently even during the interval of the first blocked data unit so that any residual signal is much smaller than the noise level when the gate is fully open.

If the gate is not synchronized with the signal, or not well synchronized, then the amplitude and phase of the transformed signal will depend not only on the data units in the gated sequence, but also on the timing of the gate relative to the signal. Any variation in the relative timing of the gate and the signal may appear like noise when the amplitude and phase of the transformed signal are measured. However, for a given sequence of data units, this “gate synchronization noise” may always affect the amplitude and phase in a fixed ratio, and this characteristic may serve to distinguish the gate synchronization noise from real noise in the original signal. Nevertheless, synchronizing the gate with the signal has the potential advantage that it may be easier to analyze the measurements to determine the OSNR.

Alternatively, instead of the admitted sequences having six data units, they have fewer than six data units, or more than six data units, and the intervals between the sequences are greater than, or less than, ten data units. If there are too few data units in each sequence, then, for the same ratio of admitted to blocked bits, there will be more sequences per second, and a faster detector will be needed. (This assumes that the detector is still making two measurements for each admitted sequence.) Conversely, if too many data units are used in each sequence, then the data analysis becomes more difficult, and the maximum allowable noise level for which the method works will be lower. For example, if each sequence has 10 bits instead of 6 bits, there will be 1024 possible bit sequences rather than 64 possible bit sequences, and it may be more difficult to discriminate among them from the measurements of the filtered signal. If the interval between sequences is too short, then the different sequences may significantly interfere with each other, and the method may not be accurate or, for too high a noise level, may not work at all. If the interval between sequences is too long, then the method may still work just as well, but it will take more time to gather data for estimating the OSNR.

Filter, Detector, and Data Analysis

When the gated signal in fiber 112 passes through filter 116, filter 116 optionally transforms the signal linearly, and optionally, filter 116 is a frequency filter, which attenuates different real frequencies by different real attenuation factors. Alternatively, filter 116 transforms the signal nonlinearly, and/or shifts the phase of the signal as a function of frequency, as well as attenuating it. Optionally, filter 116 is a narrow band frequency filter, which substantially blocks all but a limited frequency range of the signal close to the carrier frequency, the limited frequency range being arrow compared to the bit rate of the digital signal. In particular, the bandwidth of the filter is optionally somewhat narrower than the bit rate of the signal divided by the number of bits in each gated sequence. A bandwidth of this magnitude is often well matched to the bandwidth of the detector, while making efficient use of the signal in measuring the OSNR. So, for example, if the digital signal has a bit rate of 10 GHz, and there are six bits in each gated sequence, then the bandwidth of the filter is optionally somewhat narrower than 1.67 GHz. For example, the bandwidth is 900 kHz. Optionally, the bandwidth (defined as the full width at half-maximum) is more than 70% of the bit rate divided by the number of bits in each sequence, or between 50% and 70% of this frequency, or between 30% and 50% of this frequency, or less than 30% of this frequency. A method of optimizing the choice of bandwidth, and the shape of the frequency filter, will be described below, in connection with FIG. 3.

The filtered signal propagates in fiber 118 in FIG. 1, and an example of the filtered signal as a function of time is shown in a plot of signal 120. Detector 122 optionally measures the amplitude and phase of the filtered signal once for each gated sequence, and sends the results of the measurements to a digital signal processor 124. Optionally digital signal processor 124 is the same as a controller 126, which controls the timing of gate 110 and detector 122, ensuring that the measurements are made at a same time relative the beginning of each gated sequence. Alternatively, the digital signal processor and controller are separate. Optionally, filter 116 admits two narrow bands of frequency, symmetrically located around the carrier frequency. This arrangement has the potential advantage that the components of the signal filtered by each of the two bands interfere with each other, producing beat waves, as shown in plot 120. These beat waves make it possible to determine the phase of each component by measuring the amplitude of the interference pattern as a function of time. Alternatively, the filter admits only a single narrow frequency band, and any other means known to the art is used to measure the phase of the filtered signal.

Optionally, detector 122 measures the intensity of the filtered signal at two different times, differing by a time interval that is comparable to the inverse of the bandwidth, or (what may be the same thing) comparable to the duration of the gated sequence. For example, if the original data signal in fiber 106 has a bit rate of 10 GHz, and the sequence is 6 bits long, then the two intensity measurements are optionally made 6 nanoseconds apart. With this time separation, and with the filter admitting two bands symmetrically located about the carrier frequency, the two measurements may provide good information about the amplitude and phase of each filtered component (filtered by one of the bands), in some embodiments of the invention.

Optionally detector 122, or electronics used to control it, is relatively inexpensive, and is much less sensitive at the bit rate than it is at lower frequencies, such as the bandwidth of the filter. Optionally, the detector has a minimum repetition time from the beginning of one measurement to the beginning of the next measurement, and the minimum repetition time is longer than the time interval of one data unit, or longer than two times or five times this time. With these limitations, the detector may not be able to measure the OSNR of the original digital signal directly, as a more expensive detector might be capable of doing.

Optionally, instead of using the two measurements of amplitude of the beat wave to find the amplitude and phase of its components, the two measurements of amplitude of the beat wave are used instead of the amplitude and phase of the components, in order to estimate the OSNR. Instead of regarding the bit sequence of the gated high bandwidth digital signal as encoded in the amplitude and phase of the transformed signal, the bit sequence may be regarded as encoded in the amplitude of the beat waves at the two times, and it is not necessary to find the amplitude and phase of the components of the beat waves.

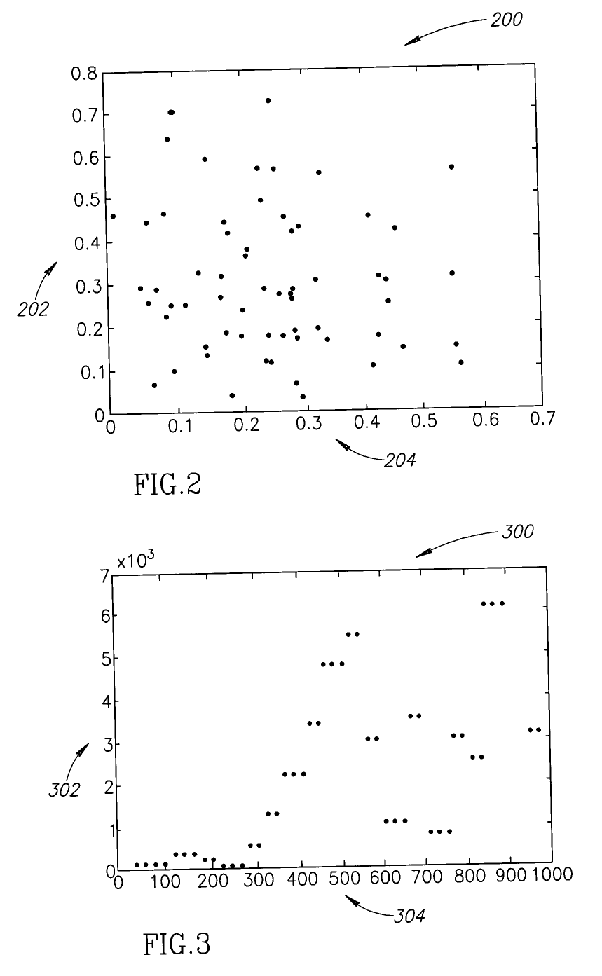

In some embodiments of the inventions, an object of the measurements is to obtain information about the unfiltered gated sequence of bits, and to be able to discriminate as well as possible between different sequences of bits. For example, if there are six bits in each sequence, then there are 64 possible sequences, each of which will produce a different filtered signal, and hence a different set of measured intensities at the two times. FIG. 2 shows a plot 200 of the expected measured intensities at two times, for each of the 64 different possible sequences of bits, in the absence of noise. The ordinate 202 of plot 200 represents the intensity at the first time, normalized to the maximum intensity of the unfiltered signal, and the abscissa 204 represents the intensity at the second time. Thus, each point in plot 200 represents an ordered set of the two intensity measurements. The two times are respectively at the beginning and end of the unfiltered gated sequence, so they are 6 nanoseconds apart if the bit rate of the optical signal is 10 GHz. The bandwidth of each of the two bands is 900 MHz. To the extent that none of the 64 points plotted in plot 200 are too close to each other, the measurements make it possible to determine the unfiltered bit sequence. This may be done, for example, by seeing where the measurement falls on plot 200, and finding the closest one of the 64 points.

Alternatively, instead of measuring the amplitude at two different times, the amplitude is measured at only one time, or at three different times, or at more than three times. (For any of these measurements, a direct measurement of the phase is optionally made, instead of a measurement of the amplitude.) For example, the filter is optionally a highly nonlinear filter which produces a transformed signal whose amplitude is proportional to the binary number indicated by the bit sequence, between 0 and 63 in the case of a sequence that is 6 bits long. Then, by measuring the amplitude of the filtered signal to sufficient precision, the sequence of bits may be determined. A potential advantage of using a linear narrow band frequency filter and making two measurements of intensity, is that it is not necessary for the measurement of intensity to be so precise. Optionally, three or more measurements of intensity (or phase) are made at different times, but this may not result in much better discrimination between different sequences of bits, since, for a given amplitude and phase of the filtered signal, knowing the intensity at two different times may make it possible, in the absence of noise, to predict the intensity at the third time.

Optionally, the bandwidth of the filter is chosen to maximize the distance in plot 200 between the closest points. FIG. 3 shows a plot 300 of the distance between the closest two points in plots like plot 200, calculated for different values of bandwidth, ranging from 0 to 1000 MHz. The distance between the closest two points is ordinate 302 of plot 300, and the bandwidth of the frequency filter is abscissa 304 of plot 300. The other parameters are all the same as in plot 200, namely the bit rate of the digital signal is 10 GHz, and there are six bits in a sequence. The interval between sequences, when the signal is blocked, is sufficiently long so that consecutive sequences do not significantly interfere with each other. The filter, in plot 300 as well as in plot 200, is square function of frequency, centered at the carrier frequency. Alternatively, another function of frequency is used, for example a Kaiser window. As will be discussed below, using a Kaiser window may help to reduce interference between consecutive sequences when the interval between them is not very long. As may be seen in plot 300, the minimum distance between points with these parameters is greatest when the bandwidth is 900 MHz, and that is why a bandwidth of 900 MHz was chosen for plot 200.

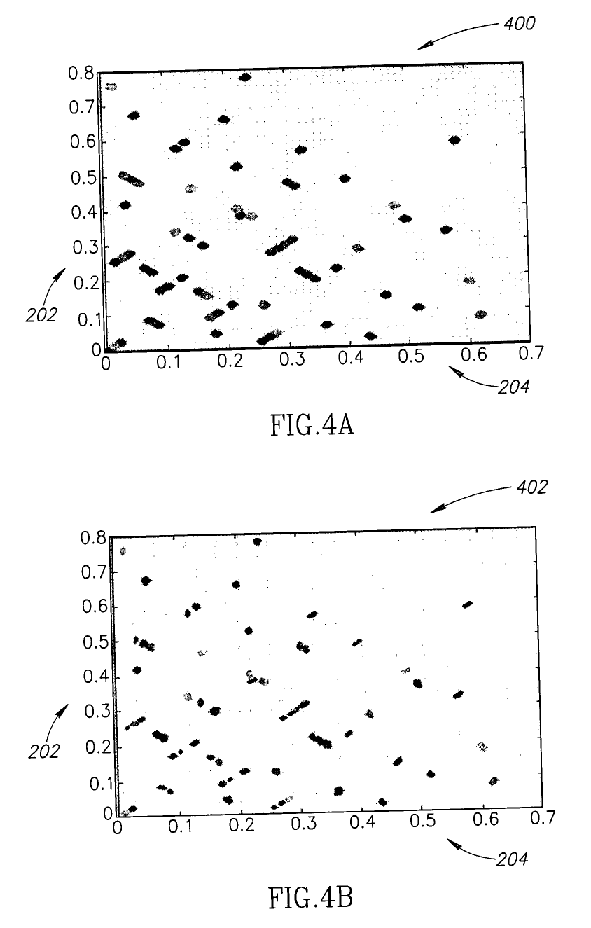

In order to estimate the OSNR, the measurement of the intensity of the filtered signal by detector 122, for example at two times as in FIG. 2, is repeated for many sequences. The results of the measurements are stored and analyzed by digital signal processor 124. FIGS. 4A and 4B are plots 400 and 402, showing (from a simulation) the results that would be obtained from measuring the intensities for a large number of sequences, in the presence of noise. In FIG. 4A, the noise is white noise with much broader bandwidth than 10 GHz, at an amplitude of −23 decibels, relative to the signal, integrated out to 10 GHz, while in FIG. 4B, the noise is amplitude noise, i.e. the amplitude of the digital signal is allowed to vary randomly by ±0.5% rms from one bit to the next, but is constant within each bit. The results are similar in the two cases. Instead of a single point in the plot corresponding to each of the 64 possible sequences of six bits, as in plot 200, each of the 64 points in plot 200 is replaced in plots 400 and 402 by a smeared out cluster of points, due to the noise. By measuring the size of one or more of these clusters, for example finding the square root of a linear combination of the variances of the x and y coordinates of the points in the cluster, or using another measure of spread, an estimate may be made of the relative noise level, i.e. the OSNR. Alternatively, the size of a cluster may be determined by taking measure (for example, the root mean square) of the differences between each of the points in the cluster and the position of the corresponding point in the absence of noise. The latter method may be more accurate if there are only a few points in each cluster. The relationship between OSNR and the size of the clusters may be calibrated, for example, by computing simulated plots, such as plots 400 and 402, with known level of OSNR, or by experimentally measuring the size of the clusters with a known level of OSNR. Optionally, by measuring the shapes of the clusters, or the skew of the clusters, or higher moments, or a combination of these, information may be obtained about the relative importance of amplitude noise and white noise, or about other characteristics of the noise.

In order to estimate the OSNR, it is not necessary to determine the bits for each sequence, by computing the expected results of the intensity measurements in the absence of noise, as in plot 200. It is sufficient to measure the intensities of the filtered signals, with noise, for a large number of sequences, to observe how they cluster into groups such as those of plot 400 or plot 402, and to measure the spread of one or more of the clusters. Optionally, the measured intensities for each sequence are stored in memory, and the sequences are then assigned to clusters. Alternatively, the sequences are assigned to clusters “on the fly,” using an algorithm which depends only on the measured intensities for the sequence that is currently being assigned, and for sequences that have already been assigned (or perhaps on a distribution of measured intensities for already assigned sequences).

Typically all of the clusters have about the same spread, so it is not necessary to measure the spreads of all of them. Statistically significant results may be obtained if a large enough number of sequences are measured so that at least one of the 64 clusters has several points in it. The number of sequences needed depends on statistical properties of the data units in the original digital signal, which may be different for real data than for data units chosen randomly with a uniform distribution, for example.

Alternatively, if a plot such as plot 200 is computed theoretically, then the OSNR may be estimated fairly accurately by measuring only a small number of sequences, far fewer than 64. Even making a pair of intensity measurements of a single filtered sequence with noise, and comparing the results to the expected results without noise, can yield a rough estimate of the OSNR.

Optionally, the measurement results from a plurality of sequences are stored in memory as they are made, and the OSNR is calculated later. In an alternative embodiment, a noise level is estimated in real time from the measurement results of each sequence, and a cumulative average noise level is calculated as more sequences are measured, without necessarily storing the measurement results for each sequence.

However the OSNR is computed from the measurement results, the computations are optionally done by dedicated hardware, or by firmware, or by software on a general purpose computer, optionally combined with controller 126 and/or digital signal processor 124. Optionally, the computations comprise table look-ups. A data analyzer which computes the OSNR from the measurement results, whether or not it is combined with controller 126 or digital signal processor 124, need not be packaged together with the rest of the elements shown in FIG. 1. The data analyzer, or software that it uses, is optionally packaged as a stand alone unit, to be used with any gate, filter, and detector. Alternatively or additionally, a stand alone device is provided which includes the gating function and which can be selectively attached to various optical networks.

Optionally, each measurement of the intensity of the filtered signal is made over a time period short compared to the time between measurements. Alternatively, each measurement integrates the filtered signal power over a substantial period of time, possibly over the entire time until the next measurement begins, but preferably not for such a long time that the measurement overlaps the next gated sequence.

As discussed above, it may be advantageous to avoid interference between adjacent sequences as much as possible in the filtered signal, since such interference will distort the shape of the filtered signal in different ways, depending on the sequence of bits in the adjacent sequences, and hence will mimic noise. Such interference may be very small if the gate blocks out the signal between sequences for a sufficiently long interval, much longer than the sequence length, but using such a strategy will mean that the OSNR estimate takes much more time than would be necessary if the signal could be blocked for a shorter interval. To keep interference between sequences at a low level, without blocking the signal for too long an interval from one sequence to the next, a Kaiser window is optionally used for the frequency filter. A Kaiser window has the form

$$w [ n ] = \frac{{I}_{0} [ β \sqrt{1 - ( \frac{n - α}{α} )} ]}{{I}_{0} ( β )}$$

where I₀ is the zero order modified Bessel function and α, β are parameters of the window. A Kaiser window has a Fourier transform with very reduced side lobes, beyond the inverse of the bandwidth. So, for example, if the bandwidth in 900 MHz, then the Fourier transform of the filter is very small outside an interval 1.11 nanoseconds long, and there will be little interference between adjacent sequences if the blocked interval between sequences is more than 1.11 nanoseconds long. Optionally, as discussed above, the filter function consists of two Kaiser windows, possibly of different phase, symmetrically arranged around the carrier frequency, producing beat waves in the filtered signal. Particularly if the two Kaiser windows are not too close together, the Fourier transform of the filter function may still have reduced side lobes.

Jitter, or random variation in the timing of the measurement, can also mimic noise, so it is advantageous to use a gate and a detector which do not have too much jitter. Simulations show that even jitter of as great as 20 picoseconds, with a 10 GHz bit rate, does not introduce an apparent noise level that is greater than typical actual noise levels due to Amplifier Spontaneous Emission. Since the inexpensive electronics suitable for the detector, for example a gallium arsenide detector, typically has jitter of only a few picoseconds, jitter is not expected to be a problem.

Another instrumental effect that can mimic noise is the finite response time of the gate. Again, simulations indicate that this is not a problem, using a gate comprising a lithium niobate controllable polarization rotator, or an indium phosphate electroabsorption gate.

While the embodiments have been described with respect to a single channel, a same aperture may be used for multiple channels, for example in a WDM system. the analysis may be performed on each channel separately, for example, by selectively gating different wavelengths or using suitable manual filters. Selective gating may also be used for selecting channels defined using methods other than WDM. Alternatively, a plurality of channels are analyzed together, for example in parallel or with the analysis treating multiple channels as a single channel, especially if the channels are synchronized.

The invention has been described in the context of the best mode for carrying it out. It should be understood that not all features shown in the drawing or described in the associated text may be present in an actual device, in accordance with some embodiments of the invention. In addition, some embodiments of the invention may includes fewer than all the features described herein or may include features form a plurality of embodiments described herein. Also included in the scope of the invention are various implementations, including programmable, hardware, ASIC and firmware implementations.

Furthermore, variations on the method and apparatus shown are included within the scope of the invention, which is limited only by the claims. Also, features of one embodiment may be provided in conjunction with features of a different embodiment of the invention. Section heading where provided are for clarity only and should not be construed to limit the description in a section to only the subject of the heading. As used herein, the terms “have”, “include” and “comprise” or their conjugates mean “including but not limited to.”

1. A method of in-channel estimation of the OSNR of an optical signal comprising a series of transmitted data units, each data unit having one of a discrete set of different amplitudes, the method comprising:
a) selecting a portion of the signal;
b) measuring, at least once, at least an indication of the selected portion of the signal;
c) repeating selecting a portion of the signal, and measuring; and
d) estimating the OSNR from the results of at least one of the measurements, wherein consecutive measurements begin at times which differ by more than a shortest interval from one data unit to the next data unit.

2. A method according to claim 1, and including transforming the selected portion of the signal before measuring, wherein the indication of the selected portion of the signal comprises the transformed signal.

3. A method according to claim 2, wherein selecting a portion of the signal comprises temporally gating the signal to admit a sequence of N data units, where N is an integer, and repeating selecting a portion of the signal comprises repeating the temporal gating with the same or a different integer N.

4. A method according to claim 1, wherein the data units are transmitted at substantially same time intervals.

5. A method according to claim 1, wherein estimating the OSNR comprises determining a difference between the result of the at least one measurements, and an expected noiseless result of said measurement.

6. A method according to claim 5, and including calculating the expected noiseless result for the at least one measurements.

7. A method according to claim 3, wherein repeating the temporal gating comprises using a same N for each of a plurality of the repetitions.

8. A method according to claim 7, wherein said N is greater than 7.

9. A method according to claim 7, wherein said N is 7.

10. A method according to claim 7, wherein said N is 6.

11. A method according to claim 7, wherein said N is 5.

12. A method according to claim 7, wherein said N is 4.

13. A method according to claim 7, wherein said N is 2 or 3.

14. A method according to claim 1, wherein the discrete set comprises only two different amplitudes.

15. A method according to claim 1, wherein one of the amplitudes in the discrete set is zero.

16. A method according to claim 3, wherein, for at least one repetition, gating the signal comprises blocking N/2 or fewer data units after admitting the sequence of N data units.

17. A method according to claim 3, wherein, for at least one repetition, gating the signal comprises blocking between N/2 and N data units after admitting the sequence of N data units.

18. A method according to claim 3, wherein, for at least one repetition, gating the signal comprises blocking between N and 2N data units after admitting the sequence of N data units.

19. A method according to claim 3, wherein, for at least one repetition, gating the signal comprises blocking more than 2N data units after admitting the sequence of N data units.

20. A method according to claim 3, wherein the transformation is linear.

21. A method according to claim 2, wherein the transformation is nonlinear.

22. A method according to claim 20, wherein the transformation comprises a frequency filter.

23. A method according to claim 22, wherein the frequency filter comprises a low-pass filter.

24. A method according to claim 23, wherein the filter is symmetric around the carrier frequency of the optical signal.

25. A method according to claim 24, wherein the filter has at least one local maximum located on each side of the carrier frequency.

26. A method according to claim 23, wherein the filter comprises a Kaiser window.

27. A method according to claim 23, wherein repeating the temporal gating comprises using a same value of N for each repetition, and a bandwidth of the filter, defined as full width at half maximum, is less than the average data unit transmission rate divided by N, but greater than or equal to 70% of the average data unit transmission rate divided by N.

28. A method according to claim 23, wherein repeating the temporal gating comprises using a same value of N for each repetition, and a bandwidth of the filter, defined as full width at half maximum, is less than 70% of the average data unit transmission rate divided by N, but greater than or equal to 50% of the average data unit transmission rate divided by N.

29. A method according to claim 23, wherein repeating the temporal gating comprises using a same value of N for each repetition, and a bandwidth of the filter, defined as full width at half maximum, is less than 50% of the average data unit transmission rate divided by N, but greater than or equal to 30% of the average data unit transmission rate divided by N.

30. A method according to claim 23, wherein repeating the temporal gating comprises using a same value of N for each repetition, and a bandwidth of the filter, defined as full width at half maximum, is less than 30% of the average data unit transmission rate divided by N.

31. A method according to claim 1, wherein measuring comprises measuring with only one detector.

32. A method according to claim 1, wherein the consecutive measurements begin at times which differ by at least two times the shortest interval.

33. A method according to claim 32, wherein the consecutive measurements begin at times which differ by at least five times the shortest interval.

34. A method according to claim 3, wherein the consecutive measurements begin at times which differ by at least N/2 times the shortest interval, for the smallest N.

35. A method according to claim 34, wherein the consecutive measurements begin at times which differ by at least N times the shortest interval, for the smallest N.

36. A method according to claim 3, wherein the consecutive measurements begin at times which differ by at most 10 times the shortest interval.

37. A method according to claim 6, wherein calculating an expected noiseless result for a measurement comprises:
a) calculating a set of expected results, one for each member of a set of possible sequences of data units, each data unit having one of the discrete set of amplitudes; and
b) determining which result from the set of expected results is closest to the actual result of said measurement.

38. A method according to claim 37, wherein repeating gating the signal comprises using a same value of N for each repetition, and the set of possible sequences of data units comprises all of the possible sequences of N data units, each data unit having one of the discrete set of amplitudes.

39. A method according to claim 3, wherein measuring at least once comprises making a first measurement and a second measurement for each of a plurality of the sequences.

40. A method according to claim 39, wherein estimating the OSNR comprises:
a) grouping the plurality of the sequences into clusters, according to a distribution of the results of the first and second measurements for each sequence in the plurality;
b) calculating a spread of the sequences in each cluster; and
c) using the spread of the sequences in at least one cluster to estimate the OSNR.

41. A method according to claim 40, and including storing the measurement results for each sequence in the plurality before grouping the plurality of sequences into clusters, and grouping comprises using the stored results.

42. A method according to claim 41, wherein grouping the sequences comprises using an algorithm which assigns a sequence to clusters based on the measurement results of said sequence and on a distribution of measurement results of previously assigned sequences, and not on the measurement results of other sequences.

43. A method according to claim 40, wherein calculating a spread comprises:
a) calculating a variance of at least one function of first measurement results and second measurement results in said cluster; and
b) setting the spread equal to a function of the at least one variances.

44. A method according to claim 40, and including:
a) analytically calculating the spread in the at least one cluster that would be obtained with a known value of OSNR; and
b) calibrating the relationship between the spread in the at least one cluster and the OSNR, using the calculated spread.

45. A method according to claim 40, and including:
a) experimentally measuring the spread in the at least one cluster that is obtained with a known value of OSNR; and
b) calibrating the relationship between the spread in the at least one cluster and the OSNR, using the experimentally measured spread.

46. A method according to claim 40, wherein the plurality of the sequences comprises a sufficiently large number of the sequences so that at least one of the clusters has at least two sequences.

47. A method according to claim 39, wherein for each sequence in the plurality, the first measurement is made starting at a same first time after the beginning of the transmission of the first data unit in said sequence, and the second measurement is made starting at a same second time after said beginning.

48. A method according to claim 39, wherein for each sequence in the plurality, the first measurement is a measurement of amplitude and the second measurement is a measurement in phase.

49. A method according to claim 39, wherein for each sequence in the plurality, the first and second measurements are measurements of amplitude.

50. A method according to claim 39, wherein for each sequence in the plurality, the first and second measurements are measurements of phase.

51. A method according to claim 5, wherein estimating the OSNR comprises calculating an average value of the differences determined for a plurality of the at least one measurements.

52. A method according to claim 51, wherein the average value is the root mean square of the differences.

53. A method according to claim 51, and including calibrating the relation between the average value and the OSNR by analytically modeling the average value that would be obtained with a known OSNR.

54. A method according to claim 51, and including calibrating the relation between the average value and the OSNR by experimentally finding the average value using a known OSNR.

55. Apparatus adapted for in-channel estimation of the OSNR of a digital signal comprising a series of data units transmitted at a data rate less than or equal to a maximum data rate, each data unit having one of a discrete set of different amplitudes, the apparatus comprising:
a) a gate which gates the digital signal, selectively blocking data units transmitted at some times while allowing data units transmitted at other times to pass through;
b) a filter which filters the gated signal, substantially reducing frequency components at frequencies comparable to the maximum data rate;
c) a detector which makes measurements of the filtered signal; and
d) a data analyzer which is operative to estimate the OSNR using results of the measurements.

56. Apparatus according to claim 55, and including a controller which controls the detector to make measurements during specified intervals of time related to the timing of the gate.

57. Apparatus according to claim 55, wherein the gate is capable of going from a closed state where the data units are substantially blocked, to an almost fully open state where the fraction of admitted signal power is close to its maximum value, in a response time that is less than the time needed to transmit five data units at the maximum data rate.

58. Apparatus according to claim 57, wherein the response time is less than the time needed to transmit one data unit at the maximum data rate.

59. Apparatus according to claim 58, wherein the response time is less than one fifth of the time needed to transmit one data unit at the maximum data rate.

60. Apparatus according to claims 55, wherein the detector is substantially less sensitive at the maximum data rate than it is at substantially lower frequencies.

61. Apparatus according to claim 55, wherein the detector has a measurement repetition time that is longer than the time needed to transmit one data unit at the maximum data rate.

62. Apparatus according to claim 61, wherein the measurement repetition time is longer than the time needed to transmit two data units at the maximum data rate.

63. Apparatus according to claim 62, wherein the measurement repetition time is longer than the time needed to transmit five data units at the maximum data rate.

64. An apparatus according to claim 55, wherein the apparatus is portable, and is adapted to be serve as a OSNR analyzer for a plurality of different optical networks.

65. An optical network comprising:
a) an optical path carrying an optical signal comprising a series of transmitted data units, each data unit having one of a discrete set of different amplitudes;
b) an apparatus for the in-channel estimation of the OSNR, according to claim 55; and
c) a beam divider for diverting a portion of the power of the optical signal from the optical path to the apparatus.

66. An optical network according to claim 65, wherein the beam divider is a partially reflecting substantially flat surface oriented at an oblique angle to the optical path.
